(19) United States
(12) Patent Application Publication
(10) Pub. No.: US 2025/0208578 A1
(43) Pub. Date: Jun. 26, 2025

(54) ARRANGEMENT OF A DISPLAY MODULE ON A PLATE

(71) Applicant: Montres Breguet S.A., L'Abbaye (CH)

(72) Inventor: Jérôme MACE, La Pont (CH)

(73) Assignee: Montres Breguet S.A, L'Abbaye (CH)

(21) Appl. No.: 18/953,639

(22) Filed: Nov. 20, 2024

(30) Foreign Application Priority Data
Dec. 21, 2023 (EP) 23219299.7

(51) Int. Cl. G04B 37/12; G04B 19/20

(52) U.S. Cl. CPC G04B 37/12; G04B 19/202

(57) ABSTRACT

A horological assembly (10) including a watch display module (1) and a plate (2) of a horological movement of the watch, the display module (1) being provided with at least one display component (4) and with a protective element (3) including an open recess in which is arranged the at least one display component (4) provided with a visible face (8) positioned facing a completely or partially transparent bottom of this recess, the protective element (3) including tabs (6a, 6b) helping to arrange this element in the plate (2).

### CROSS REFERENCE TO RELATED APPLICATIONS

This application claims priority to European Patent Application No. 23219299.7 filed Dec. 21, 2023, the entire contents of which are incorporated herein by reference.

### TECHNICAL FIELD OF THE INVENTION

The present invention relates to an arrangement of a display module on/in a plate. More specifically, the invention relates to a horological assembly comprising a watch display module and a plate of a horological movement of the watch.

### TECHNOLOGICAL BACKGROUND

Prior art documents describe an arrangement of a display module, consisting solely of a dial, on a plate by a technique consisting of locking the tabs of this dial by means of corresponding dial keys.

One of the drawbacks of this technique is that the dial tabs are fragile and can easily break in the event of an impact. As the dial tabs are not in themselves repairable, and the entire dial must be replaced, provided it is still available as a spare part, which is not always the case.

In this context, it is clear that there is a need to find an alternative solution to that of the prior art.

### SUMMARY OF THE INVENTION

One of the aims of the invention is to overcome the above and other drawbacks by providing a horological assembly in which a watch display module is arranged on/in a plate using novel arrangement techniques which are unobtrusive, simple and reliable.

The invention relates to a horological assembly comprising a watch display module and a plate of a horological movement of the watch, the display module being provided with at least one display component and with a protective element including an open recess in which is arranged said at least one display component provided with a visible face positioned facing a completely or partially transparent bottom of this recess, said protective element comprising tabs/lugs helping to arrange this element in the plate. In other embodiments:
the plate comprises a cavity for each tab, the cavity including an enclosure emerging through an opening on an upper face of this plate, said enclosure being configured to receive the tab of the protective element;
the plate comprises a cavity for each tab provided with an enclosure capable of receiving this tab and in which enclosure a fastening element is capable of being in contact with this tab in order to fasten this tab within this enclosure;
the plate comprises a through-hole extending from the side wall of the plate into the enclosure of each cavity, said hole being configured to receive a tab-fastening element in order to help fasten this tab within said enclosure;
each cavity extends through a thickness of the plate in a direction perpendicular or substantially perpendicular to the upper face of the plate;
the cavity extends through the thickness of the plate in a direction parallel or substantially parallel to the side wall of the plate;
the protective element comprises a support element provided with a contact surface intended to bear against the plate when the display module is arranged in this plate;
the support element further comprises an element for positioning the module relative to the plate;
the tabs and the support element are an extension of the end of a peripheral wall of the protective element delimiting an opening in its recess;
the plate comprises an orifice on its upper face configured to receive said positioning element;
the display module comprises a pivoting element kinematically linked to a mechanism of the horological movement of the watch and which is configured to cooperate with the display component of this module to cause it to move.

Another aspect of the invention relates to a watch comprising such a horological assembly.

### BRIEF DESCRIPTION OF THE FIGURES

Other features and advantages of the invention will be better understood upon reading the following description given of a non-limiting specific embodiment of the invention, provided for illustration purposes with reference to the accompanying figures, in which:

FIGS. 1 and 2 are exploded perspective views of a horological assembly comprising a watch display module and a plate, according to one embodiment of the invention;

FIG. 3 is a perspective view of this horological assembly with the display module arranged in/on the plate, according to the embodiment of the invention;

FIG. 4 shows a top view of the horological assembly with the display module arranged in/on the plate, according to the embodiment of the invention, and

FIG. 5 is a cross-sectional view taken along V-V of FIG. 4, according to the embodiment of the invention.

### DETAILED DESCRIPTION OF THE INVENTION

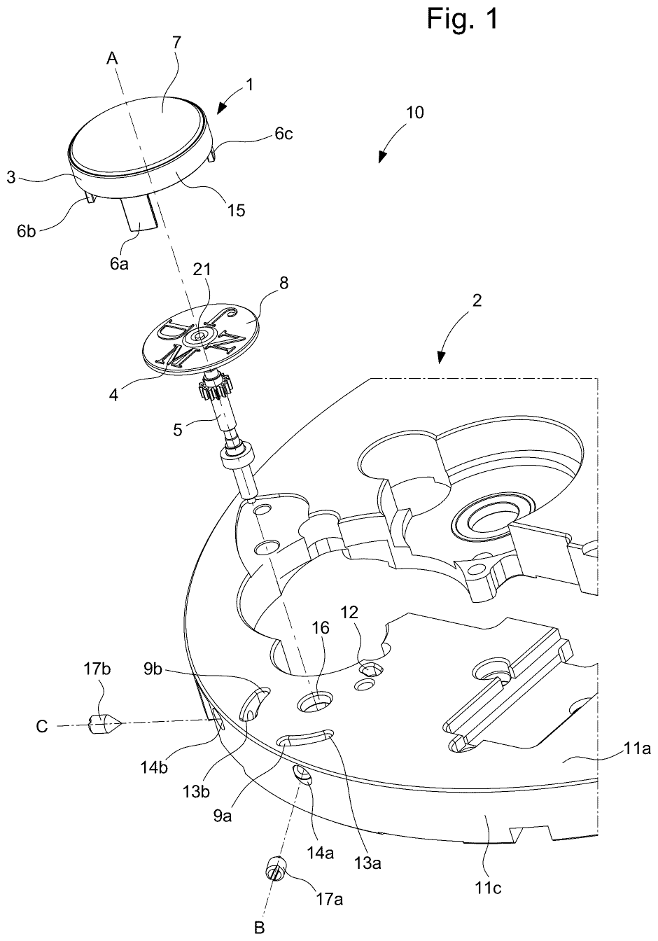

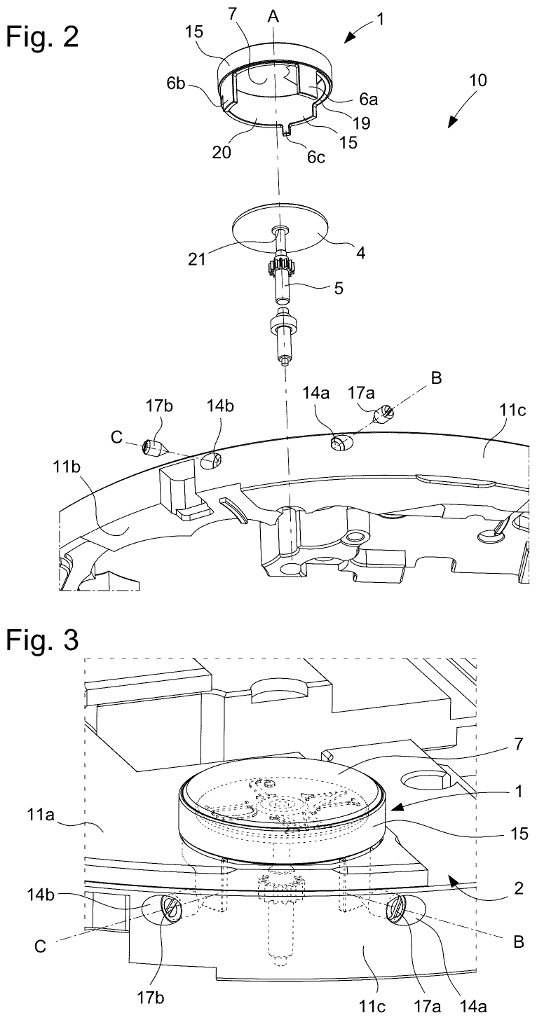

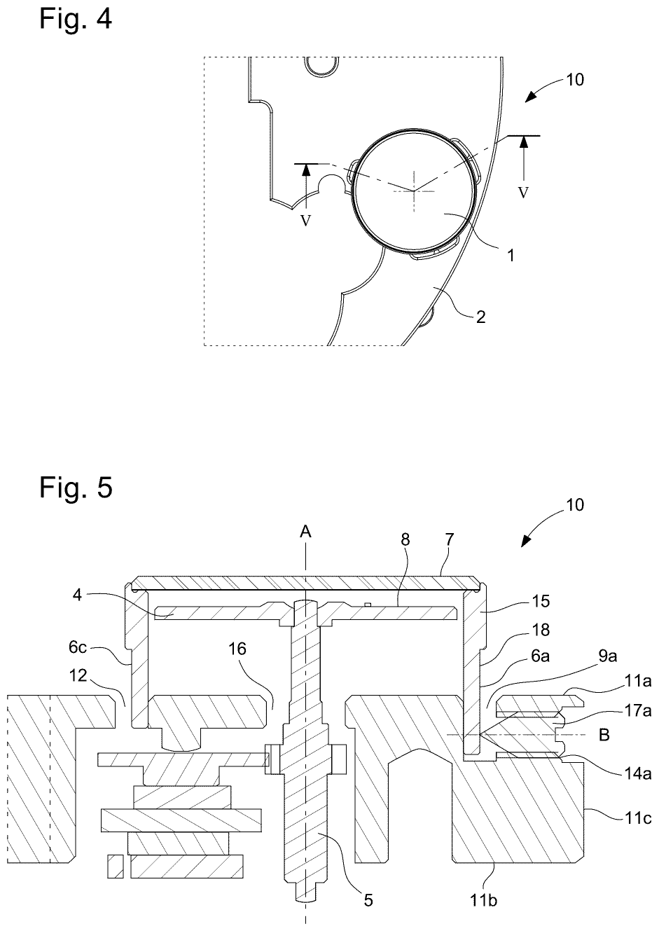

FIGS. 1 to 5 show a horological assembly 10 of a watch, in particular a wristwatch. Such an assembly 10 is included in this watch, which can be a wristwatch. In this assembly 10, a display module 1 is arranged in/on a plate 2 of a horological movement of this watch. Such an assembly 10 thus comprises this display module 1 and the plate 2. It should be noted that such a display module can concern, in a non-limitative and non-restrictive manner:
a rapid correction selector indicator for this watch, or
a date display.

In this configuration, the display module 1 comprises at least one display component 4, a protective element 3 and a pivoting element 5. The display component 4 is a movable, preferably rotatable, timepiece which participates directly in the selection, presentation and/or indication of horological information. In other words, this component 4 can comprise a graphical representation specifically involved in this selection or can be configured, for example via its shape, to carry out this selection, or this component 4 comprises at least one graphical representation corresponding to the horological information to be displayed/presented and which will thus be selected for this purpose. This component 4 can be, but is not limited to, a dial or a hand. In the present embodiment, this component 4 can be a part that can rotate about its axis of revolution A, for example, in this case, a movable dial or a movable hand. In this configuration, it should be noted that such a display component 4 can thus be driven in this rotational motion by the pivoting element 5, such as a pinion, which is kinematically linked to a mechanism of the horological movement of the watch. Such a pivoting element 5 passes through a passage zone 16 of the plate 2 connecting the display component 4 to this mechanism. It should be noted that such a mechanism can be configured to implement a rapid correction selector indicator.

As already mentioned, this display component 4 can be a dial, as shown in FIGS. 1 to 5. In this configuration, this dial can thus be fastened by driving its mounting area 21 onto a first end of the pivoting element 5 forming a pivot. It should be noted that the second end of this pivoting element 5, also forming a pivot, can be mounted in a bearing, in particular a shock-absorbing bearing.

Such a dial comprises a visible face 8 comprising at least one graphical representation used for the selection, presentation and/or indication of horological information. It should be noted that when this component 4 is a hand, the latter can also be driven onto this pivot of the pivoting element 5.

In this display module 1, the protective element 3, also referred to as a cover, comprises an open recess delimited by a peripheral wall 15 and a bottom that is totally or partially transparent. This recess is intended in particular to accommodate or receive the display component 4. With reference to FIGS. 1 to 3, this protective element 3 is made up of two parts 7a, 7b:
a first part 7a of essentially annular shape provided with opposing openings of substantially the same cross-section and which are interconnected by said peripheral wall 15, and
a second part 7b, which is entirely or partially transparent, intended to be mounted in one of the two openings so as to form the bottom of the recess defined in the protective element 3.

More specifically, this second part 7b can be a crystal and is mounted in the first opening of the first part 7a. It is understood that this first opening is specifically configured to be assembled with such a second part 7b.

It is thus understood that in this protective element 3, this second part 7b can be:
entirely/completely transparent by comprising graphical representations corresponding to horological information, the selection and/or presentation of one of these items of information being carried out by a display component 4 such as a hand;
entirely/completely transparent by comprising graphical representations corresponding to horological information, the selection and/or presentation of one of these items of information being carried out by a display component 4 such as a dial, the visible face 8 of which comprises a graphical representation, for example an arrow or the representation of a hand;
entirely/completely transparent by comprising a graphical representation, for example an arrow or the representation of a hand, which selects and/or presents one item of information from among the horological information included in the graphical representations present on the visible face 8 of a display component 4 such as the dial;
partly transparent by being completely opaque, with the exception of a portion of this part 7b which is transparent and which, like an aperture, selects and/or presents information from among the horological information included in the graphical representations present on the visible face 8 of a display component 4 such as the dial;
partly transparent by being completely opaque, with the exception of an opening made in this part 7b which, like an aperture, selects and/or presents information from among the horological information included in the graphical representations present on the visible face 8 of a display component 4 such as the dial.

It should be noted that in this first part 7a, the second opening, which is defined at the end of the peripheral wall 15 of this part, thus comprises an edge 19 of this part 7a delimited by this end.

In this configuration, such a first part 7a comprises tabs 6a, 6b which help arrange the display module 1 in/on the plate 2. In this embodiment of this module 1, and in a non-exhaustive and non-limiting manner, there are two such tabs 6a, 6b. These tabs 6a, 6b are each an extension of the peripheral wall 15 of this first part 7a, extending vertically in a direction which is parallel or substantially parallel to the axis of revolution A, when this protective element 3 is mounted on the plate 2. In this context, it is understood that these tabs 6a, 6b are an extension of this peripheral wall 15 starting from the edge 19 of this first part 7a.

Moreover, such a first part 7a further comprises a support element 20 provided with a contact surface 18 intended to bear against the plate 2 when the display module 1 is arranged in this plate 2. Like the tabs 6a, 6b of the first part 7a, the support element 20 is also an extension of the peripheral wall 15. Such a support element 20 comprises an element 6c for positioning the display module 1 relative to the plate 2. This positioning element 6c is a protrusion or raised portion included on the contact surface 18 of the support element 20. This positioning element 6c is an extension of the support element 20.

In this assembly 10, the plate 2 preferably has a general shape similar to that of the watch case. This plate 2 comprises top and bottom faces 11a, 11b and a side wall 11c which joins these faces 11a, 11b together. Such top and bottom faces 11a, 11b lie in planes that are parallel or substantially parallel to each other.

Such a plate 2 comprises cavities 9a, 9b configured to receive the tabs 6a, 6b of the protective element 3 and by extension the tabs 6a, 6b of the display module 1. Each cavity 9a, 9b comprises an enclosure opening onto the upper face 11a. In other words, the cavity 9a, 9b comprises a passage opening 13a, 13b in the enclosure which is included in this upper face 11a of the plate 2.

This enclosure of the cavity 9a, 9b extends through the thickness of the plate 2 in a direction perpendicular or substantially perpendicular to the upper face 11a. It should be noted that this enclosure extends, towards the lower face 11b of the plate 2, in a direction parallel to the axis of revolution A of the display component 4. With reference to FIG. 1, this cavity 9a, 9b can have an oblong shape. In other words, a cross-section of the enclosure can have this oblong shape.

This plate 2 further comprises a through-hole 14a, 14b for each cavity 9a, 9b. This through-hole 14a, 14b comprises two openings, one opening leading into the enclosure of this cavity 9a, 9b and another into an external face of the side wall 11c of the plate 2. This through-hole 14a, 14b comprises a recess defined between these openings, in which can be arranged a fastening element 17a, 17b for fastening the tab 6a, 6b positioned in the enclosure of the cavity 9a, 9b. In other words, this recess is configured to receive a fastening element 17a, 17b, one end of which can project into the enclosure in order to come into contact with the contact surface 18 of the tab 6a, 6b positioned facing the second opening of this hole 14a, 14b, in order to fasten the tab 6a, 6b in this enclosure. In such a configuration, this recess is configured so that the other end of this fastening element 17a, 17b does not project from the external face of the side wall 11c when this fastening element 17a, 17b is holding the tab 6a, 6b in the enclosure. This through-hole 14a, 14b extends rectilinearly from the side wall 11c towards the enclosure in a direction perpendicular or substantially perpendicular to that of the cavity 9a, 9b in the thickness of the plate 2. In other words, the central axis B, C of this through-hole 14a, 14b is perpendicular or substantially perpendicular to the direction of the axis of revolution A. Such a through-hole 14a, 14b has a length which is greater than that of the fastening element 17a, 17b in order to conceal this fastening element 17a, 17b in the plate 2. It should be noted that this hole 14a, 14b can be tapped to cooperate with a fastening element 17a, 17b such as a screw.

On the other hand, this plate 2 further comprises an orifice 12 for receiving the positioning element 6c. Such an orifice 12 has a shape which is complementary to that of the positioning element 6c.

In this assembly 10, the display module 1 is arranged on the plate 2 in particular by:
fastening the tabs 6a, 6b of the protective element 3 in the cavities 9a, 9b in the plate 2 by means of fastening elements 17a, 17b which bear against the contact surfaces 18 of the tabs 6a, 6b;
bringing the protective element 3 to bear against the upper face 11a of the plate 2 by way of its support element 20;
holding the protective element 3 in its mounting position on/in the plate 2 by arranging the positioning element 6c in the orifice 12 in the plate 2;
holding the display component 4 in the recess in the protective element 3 by way of the pivoting element 5.

### NOMENCLATURE

1. Display module
2. Plate for a horological movement
3. Protective element
4. Display component
5. Pivoting element
6a, 6b. Tabs of the protective element
6c. Positioning element for positioning the protective element on the plate
7a, 7b. First and second parts forming the protective element
8. Visible face of the display component
9a, 9b. First and second cavities
10. Assembly formed by the display module and the plate
11a. Upper face of the plate
11b. Lower face of the plate
11c. Side wall of the plate
12. Orifice configured to receive the positioning element
13a, 13b. Openings in the upper face of the plate, cavities
14a, 14b. Through-hole for the fastening element
15. Peripheral wall of the protective element
16. Passage zone in the plate for the pivoting element;
17a, 17b. Fastening elements
18. Contact surface of each tab for contact with the fastening element
19. Edge of the peripheral wall
20. Support element
21. Zone for mounting the display component onto the pivoting element

1. A horological assembly (10) comprising a watch display module (1) and a plate (2) of a horological movement of the watch, the display module (1) being provided with at least one display component (4) and with a protective element (3) including an open recess in which is arranged said at least one display component (4) provided with a visible face (8) positioned facing a completely or partially transparent bottom of the recess, said protective element (3) comprising tabs (6a, 6b) helping to arrange the element in the plate (2).

2. The assembly (10) according to claim 1, wherein the plate (2) comprises a cavity (9a, 9b) for each tab (6a, 6b), the cavity (9a, 9b) including an enclosure emerging through an opening (13a, 13b) on an upper face (11a) of the plate (2), said enclosure being configured to receive the tab (6a, 6b) of the protective element (3).

3. The assembly (10) according to claim 1, wherein the plate (2) comprises a cavity (9a, 9b) for each tab (6a, 6b) provided with an enclosure capable of receiving the tab (6a, 6b) and in which enclosure a fastening element (17a, 17b) is capable of being in contact with the tab (6a, 6b) in order to fasten the tab (6a, 6b) within the enclosure.

4. The assembly (10) according to claim 1, wherein the plate (2) comprises a cavity (9a, 9b) for each tab (6a, 6b) provided with an enclosure capable of receiving the tab (6a, 6b) and in which enclosure a fastening element (17a, 17b) is capable of being in contact with the tab (6a, 6b) in order to fasten the tab (6a, 6b) within the enclosure, the plate (2) comprising a through-hole (14a, 14b) extending from the side wall (11c) of the plate (2) into the enclosure of each cavity (9a, 9b), said hole (14a, 14b) being configured to receive a fastening element (17a, 17b) for fastening the tab (6a, 6b) in order to help fasten the tab (6a, 6b) within said enclosure.

5. The assembly (10) according to claim 1, wherein the plate (2) comprises a cavity (9a, 9b) for each tab (6a, 6b), the cavity (9a, 9b) including an enclosure emerging through an opening (13a, 13b) on an upper face (11a) of the plate (2), said enclosure being configured to receive the tab (6a, 6b) of the protective element (3), each cavity (9a, 9b) extends through a thickness of the plate (2) in a direction perpendicular or substantially perpendicular to the upper face (11a) of the plate (2).

6. The assembly (10) according to claim 1, wherein the plate (2) comprises a cavity (9a, 9b) for each tab (6a, 6b) provided with an enclosure capable of receiving the tab (6a, 6b) and in which enclosure a fastening element (17a, 17b) is capable of being in contact with the tab (6a, 6b) in order to fasten the tab (6a, 6b) within the enclosure, the cavity (9a, 9b) extending through the thickness of the plate (2) in a direction parallel or substantially parallel to the side wall (11c) of the plate (2).

7. The assembly (10) according to claim 1, wherein the protective element (3) comprises a support element (20) provided with a contact surface (18) intended to bear against the plate (2) when the display module (1) is arranged in the plate (2).

8. The assembly (10) according to claim 1, wherein the protective element (3) comprises a support element (20) provided with a contact surface (18) intended to bear against the plate (2) when the display module (1) is arranged in the plate (2), the support element further comprising an element (6c) for positioning the module relative to the plate (2).

9. The assembly (10) according to claim 1, wherein the tabs (6a, 6b) and the support element (20) are an extension of the end of a peripheral wall (15) of the protective element (3) delimiting an opening in its recess.

10. The assembly (10) according to claim 1, wherein the plate (2) comprises an orifice (12) on its upper face (11a) configured to receive said positioning element (6c).

11. The assembly (10) according to claim 1, wherein the display module (1) comprises a pivoting element (5) kinematically linked to a mechanism of the horological movement of the watch and which is configured to cooperate with the display component (4) of the module (1) to cause it to move.

12. A watch comprising the horological assembly (10) according to claim 1.
